(19) United States
(12) Patent Application Publication
(10) Pub. No.: US 2006/0066893 A1
(43) Pub. Date: Mar. 30, 2006

(54) Instruction file execution device and method, recording medium, and job flow system

(75) Inventors: Yasuyuki Shimizu, Ebina-shi (JP); Hitoshi Tsushima, Ebina-shi (JP); Kenji Tsutsumi, Ebina-shi (JP); Takashi Hirata, Ebina-shi (JP); Takayuki Asako, Ebina-shi (JP); Takuya Honda, Ebina-shi (JP); Yukimasa Ishida, Ebina-shi (JP); Hiroshi Yamamoto, Ebina-shi (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/075,334

(22) Filed: Mar. 9, 2005

(30) Foreign Application Priority Data
Sep. 24, 2004 (JP) 2004-278146

(51) Int. Cl. G06F 3/12

(52) U.S. Cl. 358/1.15

(57) ABSTRACT

An instruction file execution device includes: a receiver that receives an instruction file that has a job flow described therein defining a cooperative linkage among jobs, and that instructs execution of predetermined processing of document data, and receives fee information and the document data when required; a determination section that determines whether any of the jobs being handled supplies information to a user based on the instruction file received by the receiver; a job execution section that executes the job being handled with respect to the document data received by the receiver; a fee calculator that adds fee information for the job being handled and fee information received by the receiver to derive new fee information; and a transmission section that transmits information, wherein when the determination section determines that the job being handled does not supply information to a user, the transmission section transmits, to an execution destination of any of the jobs subsequent to the job being handled, the instruction file, the document data with respect to which the job being handled has been executed, and fee information derived by the fee calculator.

### CROSS-REFERENCE TO RELATED APPLICATION

This application claims priority under 35USC 119 from Japanese Patent Application No. 2004-278146, the disclosure of which is incorporated by reference herein.

### BACKGROUND OF THE INVENTION

1. Field of the Invention

The present invention relates to instruction file execution devices and methods, recording media, and job flow systems and, more specifically, to an instruction file execution device and method in which document data is subjected to a processing over a network connection established with other devices through cooperative linkage of device-providing services, and to a recording medium and a job flow system.

2. Description of the Related Art

There is a technology relating to a distributed system in which a series of processing are executed through cooperative linkage of programs and services (functions) distributed over a network. In the system, data for cooperative processing is transferred in order of processing among devices that are linked together over a network. For such cooperative processing, input/output functions and programs operating on the devices are combined together based on users' demands for use.

To be specific, exemplified in office environments is a document processing network system of a distributed processing type. In the system, a network connection is established among devices such as scanner, facsimile, copier, or three-in-one multi type, personal computer, and mail server, and services provided by such devices are linked together for cooperative processing of document data. With such a document processing network system, the service-providing devices convey each other cooperative-linkage information indicating the cooperative relationship among the services, input/output information, and others for cooperative processing. Such cooperative-linkage information is referred to as job flow service.

Such a job flow service has not been used so far as a basis for billing, and the basis used by the conventional billing mechanism is a job.

Considered here is a case where the job-based conventional billing mechanism is applied as it is to the job-flow-service-based billing mechanism. Assuming here that each device is being handled of job execution, the devices each have to go through a billing process. For example, when devices being handled of job flow service processing are each provided with a coin kit for billing a user, the user has to first make a payment to all of the devices to activate the job flow. This is quite bothersome for the user.

With this being the case, for the user to activate a job using an instruction file, he/she is expected to pay the fee needed to execute every job indicated in the instruction file. The payment is made toward a fee collection device, which is connected to a device for job activation.

When not every job is determined as completely executable, a notification is required to be issued in advance to indicate the shortage of money.

The jobs are each priced optionally by the corresponding service-providing execution system using an instruction file, e.g., fixed charge, charge per paper, or charge per processing time. The issue here is that, with a job flow service, services varying in characteristics are to be multiprocessed. This thus leads to the difficulty of identifying a fee needed to go through an instruction file before job execution, and so far no mechanism can serve the need for a billing process.

As a possible solution, considered here is a method of calculating in advance the fee to go through an instruction file before the file is activated. Herein, the fee is listed in advance for every job. Such a method has a drawback of not correctly achieving price calculation as above when the paper count or processing time shows some change depending on a user's request, for example.

### SUMMARY OF THE INVENTION

The present invention has been made in view of the above circumstances.

A first aspect of the present invention is directed to an instruction file execution device, including: a receiver that receives an instruction file that has a job flow described therein defining a cooperative linkage among jobs, and that instructs execution of predetermined processing of document data, and receives fee information and the document data when required; a determination section that determines whether any of the jobs being handled supplies information to a user based on the instruction file received by the receiver; a job execution section that executes the job being handled with respect to the document data received by the receiver; a fee calculator that adds fee information for the job being handled and fee information received by the receiver to derive new fee information; and a transmission section that transmits information, wherein when the determination section determines that the job being handled does not supply information to a user, the transmission section transmits, to an execution destination of any of the jobs subsequent to the job being handled, the instruction file, the document data with respect to which the job being handled has been executed, and fee information derived by the fee calculator.

A second aspect of the present invention is directed to a job flow system, including: a fee information management device that receives fee information, and sequentially performs an addition of the received fee information; and an instruction file execution device including: a receiver that receives an instruction file that has a job flow described therein defining a cooperative linkage among jobs, and that instructs execution of predetermined processing of document data, and receives the document data when required; a determination section that determines whether any of the jobs being handled supplies information to a user based on the instruction file received by the receiver; a job execution section that executes the job being handled with respect to the document data received by the receiver; and a transmission section that transmits information, wherein when the determination section determines that the job being handled does not supply information to a user, the transmission section transmits, to an execution destination of any of the jobs subsequent to the job being handled, the instruction file and the document data with respect to which the job being handled has been executed, and transmits, to the fee information management device, fee information of the job being handled.

The third aspect of the present invention is also directed to a job flow system, including: the instruction file execution device of the first aspect; a fee collection device being handled of fee collection; and an instruction device that transmits, to the instruction file execution device, fee information about a fee collected by the fee collection device, and the instruction file.

The present invention is also implemented by the following execution method.

That is, a fourth aspect of the present invention is directed to an execution method, including: receiving an instruction file that has a job flow described defining a cooperative linkage among jobs and that instructs execution of predetermined processing of document data, and receives fee information and the document data when required; determining whether any of the jobs being handled supplies information to a user based on the received instruction file; executing the job being handled with respect to the received document data; adding fee information for the job being handled and received fee information to derive new fee information; and transmitting, when the job being handled is determined as not supplying information to a user, the instruction file, the document data with respect to which the job being handled has been executed, and the derived fee information, to an execution destination of any of the jobs subsequent to the job being handled.

### BRIEF DESCRIPTION OF THE DRAWINGS

Embodiments of the present invention will be described in detail based on the following drawings, wherein:

FIG. 1 is a block diagram showing the structure of a job flow service system of a first embodiment of the present invention;

FIG. 2 is a block diagram showing the structure of a multiple device;

FIG. 3 is a flowchart showing the procedure of an instruction file execution instruction system activating an instruction file after making a job-execution-destination device calculate the fee for a job flow service;

FIG. 4 is a flowchart showing the processing procedure of a multiple device calculating a fee for a job flow service;

FIG. 5 is a flowchart showing the processing procedure of a multiple device calculating the fee for a job flow service in a second embodiment of the present invention;

FIG. 6 is a block diagram showing the structure of a job flow service system of a third embodiment of the present invention;

FIG. 7 is a block diagram showing the structure of a service fee management device;

FIG. 8 is a flowchart showing the processing procedure of a multiple device 50 for making the service fee management device calculate a fee for a job flow service; and

FIG. 9 is a flowchart showing the processing procedure of a multiple device for making the service fee management device calculate a fee for a job flow service in a fourth embodiment of the present invention.

### DETAILED DESCRIPTION OF THE INVENTION

In the below, embodiments of the present invention are described in detail by referring to the accompanying drawings.

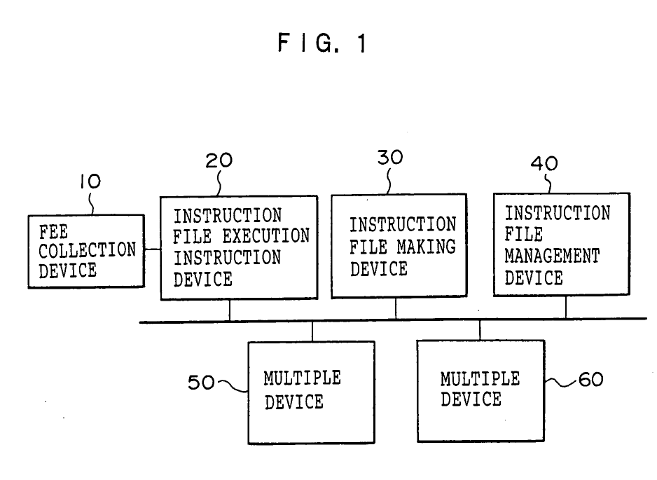

FIG. 1 is a block diagram showing the structure of a job flow service system of a first embodiment of the present invention.

Through a cooperative linkage established among various services for a document, the job flow service system executes the services as a series of cooperative processing (job flow service). Such a job flow service system operates in a system where the services are connected over a network to perform any given processing being handled of the document. Here, the document is document-related data, and not restrictively, may include image data or text data.

In this description, a file representing a job flow service that is defined for automation/standardization of a cooperative processing for the services is referred to as “instruction file”. The service here denotes a document-related predetermined processing (function), and includes printing, scanning, copying, OCR, mail distribution, folder storage, and others but not restrictive.

The job flow service system is provided with: a fee collection device 10 for collecting a fee from a user; an instruction file execution instruction device 20 to make an execution instruction of an instruction file; an instruction file making device 30 for making the instruction file; an instruction file management device 40 for storing instruction files for collective management; and multiple devices 50 and 60 for executing any given job of a job flow service based on the instruction file.

Such devices are connected to one another over a network, and the multiple devices 50 and 60 have the similar structure. Other than the devices named above, the network may be connected with printer, scanner, facsimile, computer installed with an application program, or others.

The fee collection device 10 is exemplified by a so-called coin kit or dispenser, and operates to collect a fee from a user. The fee collection device 10 may be singly provided physically as a cabinet, or plurally provided. And not restrictively, the fee collection device 10 maybe a reading device for reading fee information stored in a recording medium such as magnetic card, or a device for counting the use frequency. In a case with the device for counting the use frequency, the device may terminate the user's use when the use frequency exceeds the upper limit.

The instruction file execution instruction device 20 is exemplified by a so-called control panel, and includes a display section for displaying a plurality of instruction files, and an operation section for selecting any desired instruction file from those displayed on the display section. Whether or not the display section is made in one piece with the operation section is not an issue.

The instruction file making device 30 responds to a user's operation to create an instruction file that indicates the details of a job flow service, and calculate the service fee (execution fee) for every job of the job flow service. The resulting execution fees are written into the instruction file. The instruction file thus made in the instruction file making device 30 is then stored in the instruction file management device 40.

The multiple devices 50 and 60 are both an exemplary instruction file execution device, and once receiving an instruction file, goes through predetermined jobs in the job flow service written in the instruction file.

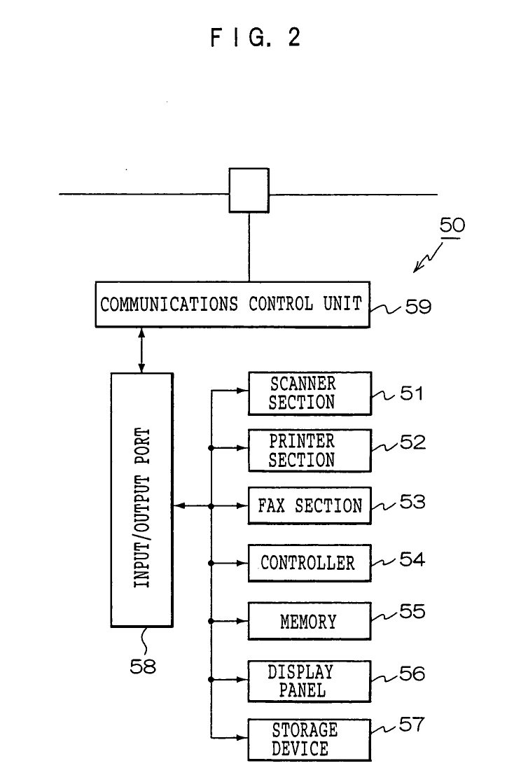

FIG. 2 is a block diagram showing the structure of the multiple device 50. The multiple device 50 can go through service processing including printing, facsimile transmission, copying, and others. The multiple device 50 sometimes manages the fee for its own service.

The multiple device 50 is provided with: a scanner section 51 for reading images on printed paper; a printer section 52; and a facsimile (hereinafter, referred to as “FAX”) section 53 for transmitting and receiving fax documents. In the printer section 52, electrostatic latent images are recorded on a photosensitive material, the resulting electrostatic latent images are developed using a monochrome toner or color toner, and thus developed images are transferred to recording paper for output.

The multiple device 50 is also provided with: a controller 54 for exercising control over a program for an instruction file execution processing; memory 55; a display panel 56; a storage device 57 for storing instruction files, and others; an input/output port 58 for data input/output; and a communications control unit 59 for communications with other devices connected over a network. The memory 55 stores image data read by the scanner section 51, and image data received over the network, and data such as received FAX documents. The display panel 56 displays an operation screen with icons, and when any icon is touched, responsively inputs operation information.

The components of the scanner section 51, the printer section 52, the FAX section 53, the controller 54, the memory 55, the display panel 56, the storage device 57, and the input/output port 58 are all connected together through a bus. The input/output port 58 is connected to the network through the communications control unit 59. The scanner section 51 may be incorporated as a part of the FAX section 53.

Here, even if every job has a fixed fee in a job flow service of an instruction file, this does not uniquely determine the fee for the job flow service in its entirety. Assuming that the job flow service includes services of “scanning”, “character recognition”, and “mail distribution” with a link thereamong, the fee for the job flow service changes depending on how many pieces of paper are scanned even if each service has its own fixed fee.

In view thereof, the job flow service system is so structured as to activate the instruction file after showing a user the fee estimated for the job flow service written in the instruction file.

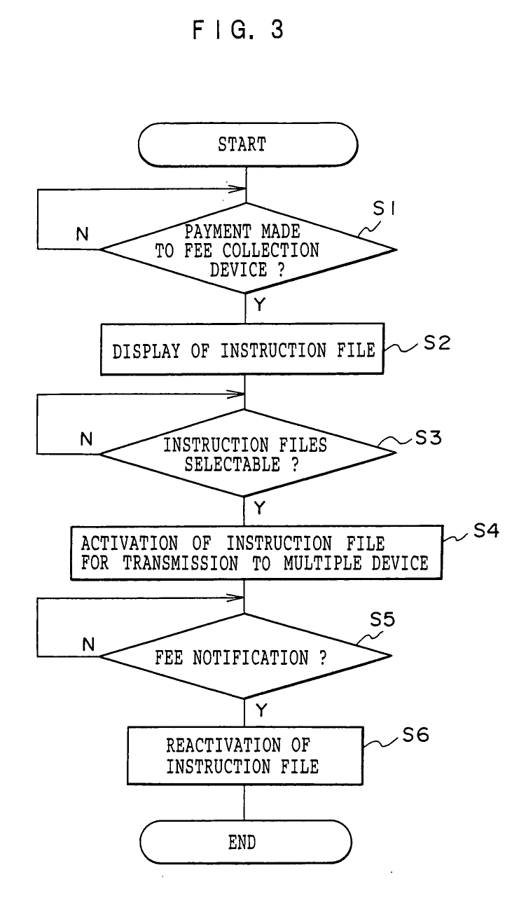

FIG. 3 is a diagram showing the procedure until the instruction file execution instruction device 20 activates the instruction file after having execution destinations of jobs calculate the fee for the job flow service. That is, the instruction file execution instruction device 20 goes through processing of steps S1 to S6 as below. In second to fourth embodiments that will be described later, the instruction file execution instruction device 20 goes through processing similarly.

The instruction file execution instruction device 20 waits until the fee collection system 10 receives a fee (step S1), and after receiving a notification from the fee collection device 10 telling that the fee is paid, displays on a display section instruction files listed in the instruction file management device 40 (step S2). With the instruction files displayed on the display section, the user operates an operation section of the instruction file execution instruction device 20 to select his/her wanting instruction file therefrom.

After selection of instruction file as such (step S3), the instruction file execution instruction device 20 activates thus selected instruction file (step S4). Here, the instruction file is activated not fully but to calculate the fee for the job flow service in the instruction file. The instruction file execution instruction device 20 then forwards the instruction file to the multiple device 50.

Thereafter, the instruction file execution instruction device 20 waits until a notification about the fee for the job flow service of the instruction file comes (step S5). When receiving the fee notification, the instruction file execution instruction device 20 displays the fee on the display section for the user to see, and encourages the user to pay the fee more than the displayed to the fee collection device 10. When the fee collection device 10 receives enough money, and when a user's instruction comes via the operation section for reactivation of the instruction file, the instruction file execution instruction device 20 accordingly reactivates, i.e., fully activates, the instruction file (step S6).

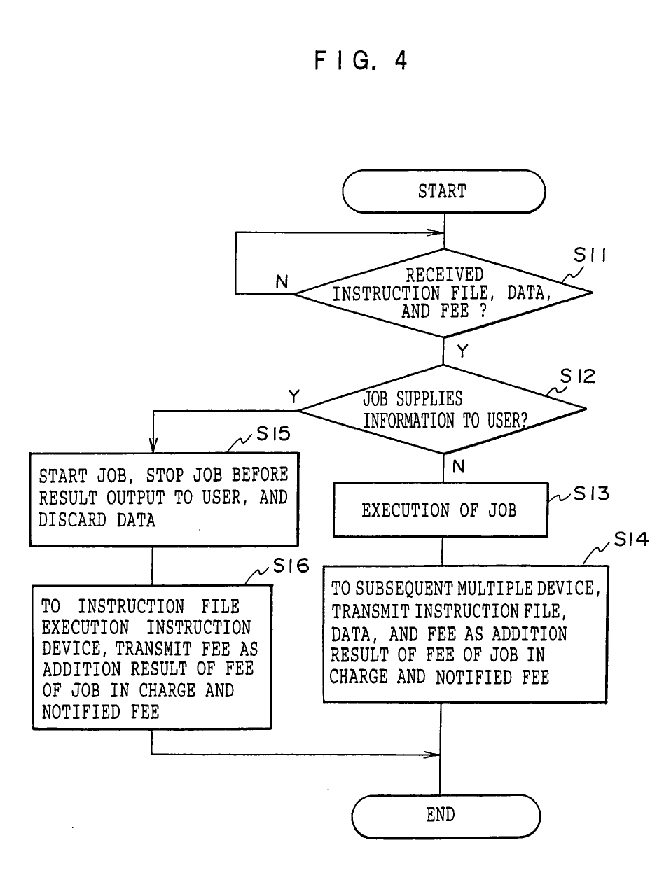

FIG. 4 is a flowchart showing the processing procedure for the multiple device 50 to calculate the fee for a job flow service. That is, the multiple device 50 goes through the processing after step S11 and onward as below.

The multiple device 50 determines whether the instruction file is received, and when required, whether the document data and the fee are also received. If determined No, the multiple device 50 waits until that (those) come(s) (step S11). Note that when executing the job listed first in the job flow service written in the instruction file, the multiple device 50 may receive only the instruction file from the instruction file execution instruction device 20.

The multiple device 50 analyzes the received instruction file to determine whether the job being handled supplies information to a user (step S12). Herein, the jobs supplying information to a user include printing, mail distribution, facsimile transmission, and others. The reason why such a determination is done is to allow the user to estimate the fee for the job flow service without execution of any job, with a consideration that these jobs are usually easy to check, and are often be the last listed in the job flow service.

When the determination is No in step S12, the multiple device 50 actually executes the job being handled (step S13), and adds together the fee resulted from the job execution and the fee received in step S11. The multiple device 50 then forwards the instruction file, the document data through with the job execution, and the resulting fee to an execution destination of the job listed next in the job flow service, e.g., multiple device 60.

On the other hand, when the determination is YES in step S12, the multiple device 50 starts the job being handled, and stops it before outputting information about the job to the user, i.e., before job completion. The multiple device 50 also discards the remaining document data obtained as a result of the job termination (step S15). Thereafter, the multiple device 50 adds the fee with a presumption that the job is completely executed together with the fee received in step S11. The resulting fee is notified to the instruction file execution instruction device 20 as a fee needed for the job flow service (step S16).

This allows the user to first check the actual fee for the job flow service, and instruct the instruction file execution instruction device 20 to activate the instruction file after completing the payment to the fee collection device 10. The user may instruct the instruction file execution instruction device 20 not to activate the instruction file.

As described above, the job flow service system of the first embodiment displays the user the correct fee for a job flow service prior to execution thereof, and encourages him/her to make a fee payment. Accordingly, the job flow service is not interrupted due to shortage of money, thereby successfully executing every service.

Described next is a second embodiment of the present invention. Herein, any component functioning similarly to that in the first embodiment is provided with the same reference numeral, and not described again if already described.

In the first embodiment, the multiple device 50 discards the remaining document data obtained as a result of the job termination in step S15. In the second embodiment, the multiple device 50 stores such document data, and outputs it if a continuation instruction comes. To be specific, the multiple device 50 goes through the following processing instead of the processing of FIG. 4.

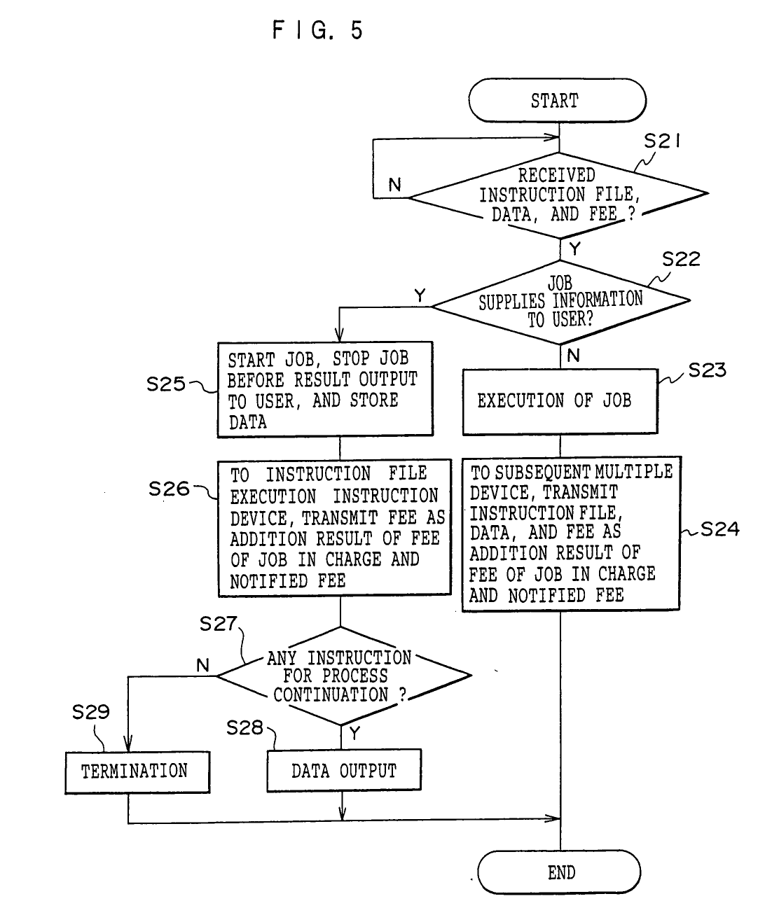

FIG. 5 is a flowchart showing the process procedure of the multiple device 50 calculating the fee for a job flow service. That is, the multiple device 50 executes the processing of step S21 and onward as below. The processing of steps S21 to S24 are similar to those of steps S11 and S14 of FIG. 4.

When the determination is YES in step S22, the multiple device 50 starts the job being handled, and temporarily stops the job before outputting information about the job to the user, i.e., before job completion. The document data left unexecuted due to job interruption is then stored (step S25). Thereafter, the multiple device 50 adds the fee with a presumption that the job is completely executed together with the fee received in step S21. The resulting fee is notified to the instruction file execution instruction device 20 as a fee needed for the job flow service (step S26).

This allows the user to first check the actual fee for the job flow service, and instruct the instruction file execution instruction device 20 to continue or terminate the processing for the job flow service. When any fee needed for the job flow service is paid to the fee collection device 10, and when the user makes an operation for a continuation of processing, the instruction file execution instruction device 20 instructs the multiple device 50 for the continuation of processing.

The multiple device 50 then determines whether or not instructed by the instruction file execution instruction device 20 for a continuation of processing (step S27). When determined YES, the multiple device 50 outputs the document data stored in step S25 as it is, e.g., printing, facsimile transmission, mail distribution, and this is the end of the process. When determined NO, the job flow service is terminated.

As described above, the job flow service system of the second embodiment displays the user the correct fee for a job flow service prior to execution thereof, and encourages him/her to make a fee payment. Accordingly, the job flow service is not interrupted due to shortage of money, thereby successfully executing every service.

What is more, the job flow service of the second embodiment merely outputs the document data in storage as it is when an instruction comes from the instruction file execution instruction device 20 for a continuation of processing. Accordingly, this leads to the result output of the job flow service at a short time after such an instruction comes.

Described next is a third embodiment of the present invention. Herein, any component functioning similarly to that in the above-described embodiments is provided with the same reference numeral, and not described again if already described.

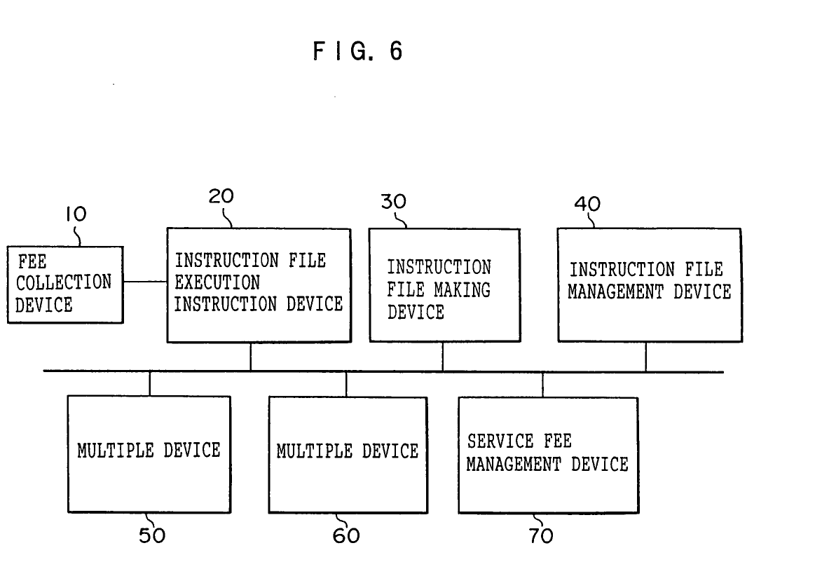

FIG. 6 is a block diagram showing the structure of a job flow service system of the third embodiment of the present invention. This job flow service system is similar to that of FIG. 1, additionally including a service fee management device 70.

The service fee management device 70 is being handled of fee estimation for the job flow service, which is done by the multiple device 50 in the first embodiment.

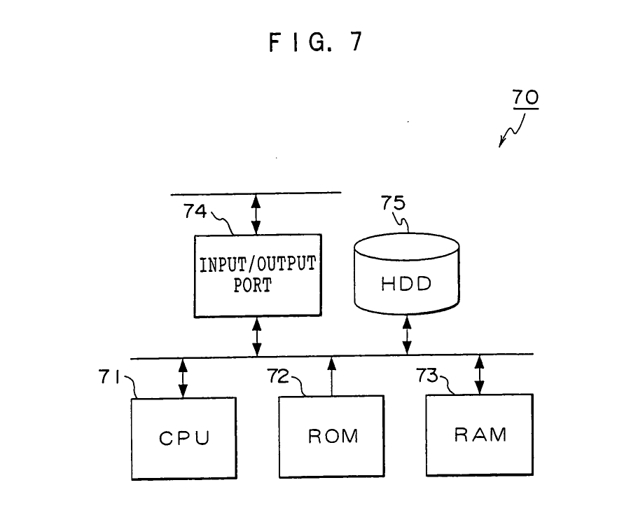

FIG. 7 is a block diagram showing the structure of the service fee management device 70. The service fee management device 70 is provided with: a CPU 71 being handled of a predetermined calculation processing such as fee calculation; ROM 72 storing a control program for the CPU 71; RAM 73 serving as a working area for data; an input/output port 74 for information transmission and reception with a network; and a hard disk drive 75 storing various information such as money balance that is input through the input/output port 74.

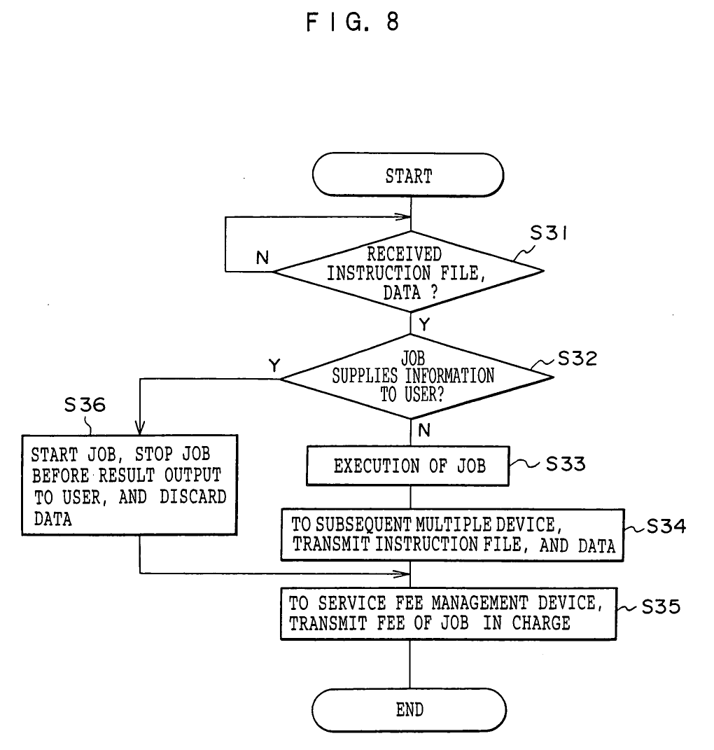

FIG. 8 is a flowchart showing the processing procedure for the multiple device 50, having the service fee management device 70 calculate the fee for the job flow service. That is, the multiple device 50 goes through processing of step S31 and onward. The processing of steps S31 to S33 are similar to those of steps S11 to S13 of FIG. 4.

The multiple device 50 goes through steps S31 to S33 to execute the job being handled, and then forwards the instruction file and the resulting document data to an execution destination of the job listed next in the job flow service, e.g., multiple device 60 (step S34). Thereafter, the multiple device 50 notifies the fee for the job being handled to the service fee management device 70 (step S35).

When the determination is YES in step S32, the multiple device 50 starts the job being handled, and stops it before outputting information about the job to the user, i.e., before job completion. The multiple device 50 also discards the remaining document data obtained as a result of the job termination (step S36), and then goes through the processing of step S35. In this step S35, the multiple device 50 may sends a notification to the service fee management device 70 telling that the job has been terminated.

After receiving the fee notification from the multiple devices 50 and 60 both for executing the jobs in the job flow service, the service fee management device 70 performs addition of the fee. When receiving a notification telling that the job has been terminated, the service fee management device 70 notifies the instruction file execution instruction device 20 of the fee for the job flow service at the point in time as a fee needed for the job flow service.

This allows the user to first check the actual fee for the job flow service through the instruction file execution instruction device 20, and instruct the instruction file execution instruction device 20 to go through the instruction file after paying the required fee to the fee collection device 10. The user may instruct the instruction file execution instruction device 20 not to activate the instruction file.

As described above, the job flow service system of the third embodiment displays the user the correct fee for a job flow service prior to execution thereof, and encourages him/her to make a fee payment. Accordingly, the job flow service is not interrupted due to shortage of money, thereby successfully executing every service.

What is more, the service fee management device 70 calculates the fee for the job flow service, thereby reducing the processing load of the instruction file execution device, i.e., multiple devices 50 and 60 in this embodiment.

Described next is a fourth embodiment of the present invention. Herein, any component functioning similarly to that in the third embodiment is provided with the same reference numeral, and not described again if already described.

In the third embodiment, the multiple device 50 discards the remaining document data obtained as a result of the job termination in step S36. In the fourth embodiment, the multiple device 50 stores the document data, and outputs it if a continuation instruction comes. To be specific, the multiple device 50 goes through the following processing instead of the processing of FIG. 8.

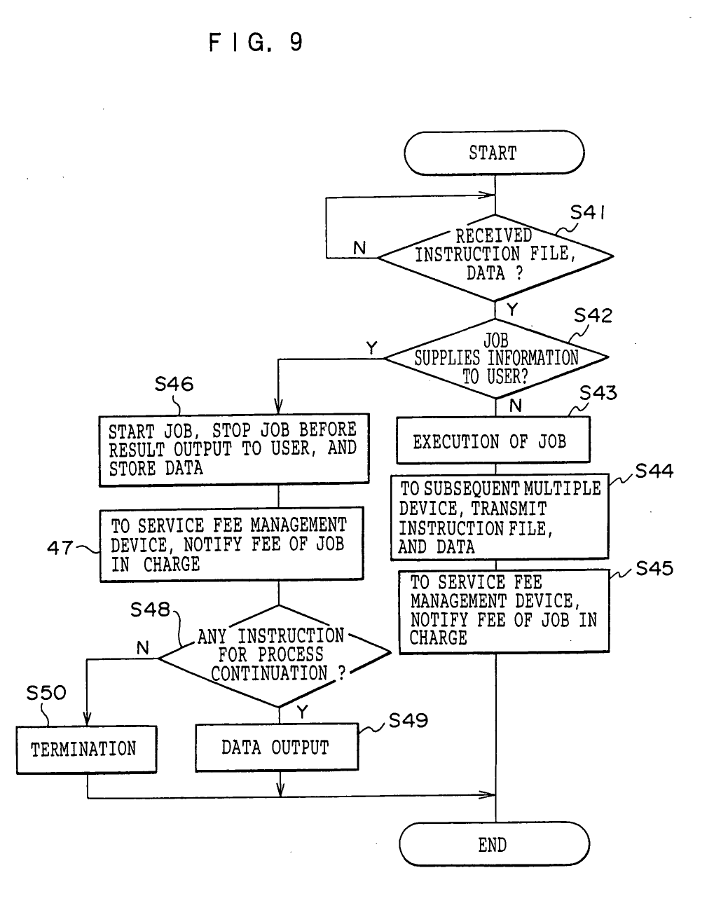

FIG. 9 is a flowchart showing the processing procedure for the service fee management device 70 to calculate the fee for a job flow service. That is, the multiple device 50 executes the processing of step S41 and onward. The processing of steps S41 to S45 are similar to those of steps S31 and S35 of FIG. 8.

When the determination is YES in step S42, the multiple device 50 starts the job being handled, and temporarily stops the job before outputting information about the job to the user, i.e., before job completion. The multiple device 50 then stores the remaining document data obtained as a result of the job interruption (step S46). Then, the multiple device 50 notifies the service fee management device 70 of the fee for the job being handled (step S47). In this step S47, the multiple device 50 may send a notification to the service fee management device 70 telling that the job has been interrupted.

After receiving the fee notification from both the multiple devices 50 and 60 being handled of the jobs for the job flow service, the service fee management device 70 performs fee addition. When receiving the notification telling that the job has been interrupted, the service fee management device 70 notifies the fee for the job flow service at the point in time to the instruction file execution instruction device 20 as a fee needed for the job flow service.

This allows the user to first check the fee for the job flow service through the instruction file execution instruction device 20, and instruct the instruction file execution instruction device 20 to continue or terminate the processing for the job flow service. When any fee needed for the job flow service is paid to the fee collection device 10, and when the user makes an operation for a continuation of processing, the instruction file execution instruction device 20 instructs the multiple device 50 for the continuation of processing.

The multiple device 50 then determines whether instructed by the instruction file execution instruction device 20 for a continuation of processing (step S48). When determined YES, the multiple device 50 outputs the document data stored in step S46 as it is, and this is the end of the process. When determined NO, the job flow service is terminated.

As described above, the job flow service system of the fourth embodiment displays the user the correct fee for a job flow service prior to execution thereof, and encourages him/her to make a fee payment. Accordingly, the job flow service is not interrupted due to shortage of money, thereby successfully executing every service. Furthermore, the service fee management device 70 calculates the fee for the job flow service, thereby reducing the processing load of the instruction file execution device, i.e., multiple devices 50 and 60 in this embodiment.

What is more, the job flow service of the fourth embodiment merely outputs the document data in storage as it is when an instruction comes from the instruction file execution instruction device 20 for a continuation of processing. Accordingly, this leads to the result output of the job flow service at a short time after such an instruction comes.

While the invention has been described in the above embodiments, the foregoing description is in all aspects illustrative and not restrictive. It is understood that numerous other modifications and variations can be devised without departing from the scope of the invention.

For example, in the first to fourth embodiments, although the multiple devices 50 and 60 are exemplified for an instruction file execution device for executing jobs in a job flow service based on an instruction file, this is surely not restrictive, and any device will do as long as being capable of executing a predetermined service following the instruction file.

As described above, some embodiments of the invention are outlined below.

An instruction file execution device includes: a receiver that receives an instruction file that has a job flow described therein defining a cooperative linkage among jobs, and that instructs execution of predetermined processing of document data, and receives fee information and the document data when required; a determination section that determines whether any of the jobs being handled supplies information to a user based on the instruction file received by the receiver; a job execution section that executes the job being handled with respect to the document data received by the receiver; a fee calculator that adds fee information for the job being handled and fee information received by the receiver to derive new fee information; and a transmission section that transmits information.

In the embodiment of this invention, the receiver receives an instruction file, and when required, receives also fee information and document data. The instruction file is data that has a job flow described therein defining a cooperative linkage among jobs, and that instructs execution of predetermined processing of document data. This instruction file is used as a basis for the instruction file execution device to execute any job being handled. The fee information received by the receiver indicates the fee for the job(s) having been completed before the point in time. The reason for the expression of “when required” is that the receiver does not always receive the fee information and the document data when the instruction file execution device executes the job listed first in a job flow.

In the embodiment of this invention, based on the instruction file, the determination section determines whether any of the jobs being handled supplies information to a user. The job supplying information to a user includes printing, mail distribution, facsimile transmission, data storage, and others, offering information to the user.

In the embodiment of this invention, the job execution section executes the job being handled with respect to the received document data. The fee calculator adds a fee for the job being handled and fee information received by the receiver to derive new fee information. The fee information derived by the fee calculator as such represents the fee amount expected to be paid for the job(s) having been completed in the job flow before the point in time.

Accordingly, in the embodiment of this invention, an instruction file is referred to determine whether the job being handled supplies information to a user. After the determination, the job being handled is executed to document data, and the fee information for the job being handled and the received fee information are added together to derive new fee information. If the determination tells that the job supplies no information to a user, the execution destination for the next job is provided with the instruction file, the document data through with the job, and the fee information calculated by the fee calculator. In this manner, the fee information required for the job flow execution can be calculated.

A job flow system includes: a fee information management device that receives fee information, and sequentially performs an addition of the received fee information; and an instruction file execution device including: a receiver that receives an instruction file that has a job flow described therein defining a cooperative linkage among jobs, and that instructs execution of predetermined processing of document data, and receives the document data when required; a determination section that determines whether any of the jobs being handled supplies information to a user based on the instruction file received by the receiver; a job execution section that executes the job being handled with respect to the document data received by the receiver; and a transmission section that transmits information.

In the embodiment of this invention, the fee information management device is for managing the fee required to go through the job flow in the instruction file, and every time fee information comes for a specific job, performs addition of the fee information sequentially.

In the embodiment of this invention, the receiver in the instruction file execution device receives the instruction file, and when required, the fee information and the document data. The reason for the expression of “when required” is that the receiver does not always receive the document data when the reception device executes the job listed first in a job flow.

Based on the instruction file, the determination section determines whether or not the job being handled supplies information to a user.

The job execution section executes the job being handled with respect to the received document data. When the job is determined as supplying no information to a user, the transmission section transmits the instruction file, and the document data with respect to which the job being handled has been executed. The transmission section also transmits the fee information about the job being handled to the fee information management device.

The fee information management device updates the fee information so that the fee information required for the jobs in the job flow so far completed is calculated.

Accordingly, in the embodiment of this invention, when determination tells that the job supplies no information to a user, the fee information for the job being handled is forwarded to the fee information management device. In response, the fee information management device performs addition of the received fee information in a sequential manner so that the fee information required to go through the job flow is calculated.

What is claimed is:

1. An instruction file execution device comprising:
a receiver that receives an instruction file that has a job flow described therein defining a cooperative linkage among jobs, and that instructs execution of predetermined processing of document data, and receives fee information and the document data when required;
a determination section that determines whether any of the jobs being handled supplies information to a user based on the instruction file received by the receiver;
a job execution section that executes the job being handled with respect to the document data received by the receiver;
a fee calculator that adds fee information for the job being handled and fee information received by the receiver to derive new fee information; and
a transmission section that transmits information, wherein
when the determination section determines that the job being handled does not supply information to a user,
the transmission section transmits, to an execution destination of any of the jobs subsequent to the job being handled, the instruction file, the document data with respect to which the job being handled has been executed, and fee information derived by the fee calculator.

2. The instruction file execution device according to claim 1, wherein
when the determination section determines that the job being handled supply information to a user,
the job execution section terminates the job being handled before information is output, and
the transmission section transmits fee information derived by the fee calculator to a predetermined terminal.

3. The instruction file execution device according to claim 2, wherein
the job execution section discards the document data that is left unexecuted due to termination of the job being handled, and when an instruction comes for reexecution of the instruction file, reexecutes the job being handled, and outputs document data obtained as a result of the job reexecution.

4. The instruction file execution device according to claim 2, wherein
the job execution section stores the document data that is left unexecuted due to termination of the job being handled, and when an instruction comes for a continuation of processing, outputs the document data in storage.

5. A job flow system comprising:
a fee information management device that receives fee information, and sequentially performs an addition of the received fee information; and
an instruction file execution device including: a receiver that receives an instruction file that has a job flow described therein defining a cooperative linkage among jobs, and that instructs execution of predetermined processing of document data, and receives the document data when required; a determination section that determines whether any of the jobs being handled supplies information to a user based on the instruction file received by the receiver; a job execution section that executes the job being handled with respect to the document data received by the receiver; and a transmission section that transmits information, wherein when the determination section determines that the job being handled does not supply information to a user,
the transmission section transmits, to an execution destination of any of the jobs subsequent to the job being handled, the instruction file and the document data with respect to which the job being handled has been executed, and transmits, to the fee information management device, fee information of the job being handled.

6. The job flow system according to claim 5, wherein
in the instruction file execution device, when the determination section determines that the job being handled supply information to a user, the job execution section terminates the job being handled before information is output, and
the fee information management device transmits fee information as an addition result to a predetermined terminal device.

7. The job flow system according to claim 6, wherein
the job execution section discards the document data that is left unexecuted due to termination of the job being handled, and when an instruction comes for reexecution of the instruction file, reexecutes the job being handled, and outputs document data obtained as a result of the job reexecution.

8. The job flow system according to claim 6, wherein
the job execution section stores the document data that is left unexecuted due to termination of the job being handled, and when an instruction comes for a continuation of processing, outputs the document data in storage.

9. A job flow system comprising:
the instruction file execution device including: a receiver that receives an instruction file that has a job flow described therein defining a cooperative linkage among jobs, and that instructs execution of predetermined processing of document data, and receives fee information and the document data when required; a determination section that determines whether any of the jobs being handled supplies information to a user based on the instruction file received by the receiver; a job execution section that executes the job being handled with respect to the document data received by the reception section; a fee calculator that adds fee information for the job being handled and fee information received by the receiver to derive new fee information; and a transmission section that transmits information, wherein when the determination section determines that the job being handled does not supply information to a user, the transmission section transmits, to an execution destination of any of the jobs subsequent to the job being handled, the instruction file, the document data with respect to which the job being handled has been executed, and fee information derived by the fee calculation section;
a fee collection device being handled of fee collection; and
an instruction device that transmits, to the instruction file execution device, fee information about a fee collected by the fee collection device, and the instruction file.

10. The job flow system according to claim 5, further comprising:
a fee collection device being handled of fee collection; and
an instruction device that transmits fee information about a fee collected by the fee collection device to the fee information management device, and transmits the instruction file to the instruction file execution device.

11. An instruction file execution method comprising:
receiving an instruction file that has a job flow described defining a cooperative linkage among jobs and that instructs execution of predetermined processing of document data, and receives fee information and the document data when required;
determining whether any of the jobs being handled supplies information to a user based on the received instruction file;
executing the job being handled with respect to the received document data;
adding fee information for the job being handled and received fee information to derive new fee information; and
transmitting, when the job being handled is determined as not supplying information to a user, the instruction file, the document data with respect to which the job being handled has been executed, and the derived fee information, to an execution destination of any of the jobs subsequent to the job being handled.

12. The instruction file execution method according to claim 11, wherein
when the job being handled is determined as supplying information to a user, the job being handled is terminated before information output, and the derived fee information is transmitted to a predetermined terminal device.

13. The instruction file execution method according to claim 12, wherein
the document data that is left unexecuted due to termination of the job being handled is discarded, and when an instruction comes for reexecution of the instruction file, the job being handled is reexecuted, and document data obtained as a result of the job reexecution is output.

14. The instruction file execution method according to claim 12, wherein
the document data that is left unexecuted due to termination of the job being handled is stored, and when an instruction comes for a continuation of processing, the document data in storage is output.

15. A recording medium storing a program executable on a computer, being operable to instruct the computer to:
receive an instruction file that has a job flow described therein defining a cooperative linkage among jobs and that instructs execution of predetermined processing of document data, and receive information and the document data when required;
determine whether any of the jobs being handled supplies information to a user based on the received instruction file;
execute the job being handled with respect to the received document data;
add fee information for the job being handled and the received fee information to derive new fee information; and
transmit, when the job being handled is determined as not supplying information to a user, the instruction file, the document data with respect to which the job being handled has been executed, and the derived fee information, to an execution destination of any of the jobs subsequent to the job being handled.

16. The recording medium according to claim 15, wherein
the program is operable to instruct the computer to execute a processing of, when the job being handled is determined as supplying information to a user, terminating the job being handled before the information is output to the user, and transmitting the derived fee information to a predetermined terminal device.

17. The recording medium according to claim 16, wherein
the program is operable to instruct the computer to execute a processing of discarding the document data that is left unexecuted due to termination of the job being handled, and when an instruction comes for reexecution of the instruction file, reexecuting the job being handled, and outputting document data obtained as a result of the job reexecution.

18. The recording medium according to claim 16, wherein
the program is operable to instruct the computer to execute a processing of storing the document data that is left unexecuted due to termination of the job being handled, and when an instruction comes for a continuation of processing, outputting the document data in storage.

19. The instruction file execution device according to claim 1, wherein at least one of the jobs of copying, facsimile transmission and reception, printing, and scanning is executed.

20. The job flow system according to claim 5, wherein the instruction file execution device executes at least one of the jobs of copying, facsimile transmission and reception, printing, and scanning.
